(19) United States
(12) Patent Application Publication
(10) Pub. No.: US 2006/0262108 A1
(43) Pub. Date: Nov. 23, 2006

(54) Display apparatus and control method thereof

(75) Inventor: Hah-young Kim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/272,836

(22) Filed: Nov. 15, 2005

(30) Foreign Application Priority Data
May 17, 2005 (KR) 2005-0041296

(51) Int. Cl. G09G 5/00

(52) U.S. Cl. 345/204

(57) ABSTRACT

A display apparatus to receive a signal which includes at least one of additional information and picture information, and process and display the signal, the apparatus including: a signal input part to receive the signal; a signal processor to convert the signal received through the signal input part into a predetermined signal level; and a controller to detect the signal level of the additional information among the signals output from the signal processor to compare with a predetermined reference signal level, and control the signal processor to output the signal level of the additional information as the reference signal level if the output signal level of the addition information and the reference signal level are different each other. Thus, there is provided a display apparatus and a control method thereof which maintains an optimum signal level automatically and displays quality additional information and better pictures, regardless of whether input signals are over-modulated or under-modulated.

### CROSS-REFERENCE TO RELATED APPLICATIONS

This application claims the benefit of Korean Patent Application No. 2005-0041296, filed on May 17, 2005, in the Korean Intellectual Property Office, the disclosure of which is incorporated herein by reference.

### BACKGROUND OF THE INVENTION

1. Field of the Invention

Apparatuses and methods consistent with the present invention relate to a display apparatus and a control method thereof, and more particularly, to a display apparatus and a control method thereof which maintains an optimum signal level automatically and displays quality additional information and better pictures, regardless of whether abnormal signals which are over-modulated or under-modulated are input.

2. Description of the Related Art

A conventional display apparatus which is available for generating additional information such as captions comprises: a display part; a picture signal receiver to receive a picture signal including additional information; a signal level converter to convert the picture signal input through the picture signal receiver into a predetermined signal level; a decoding part to decode the picture signal which is converted in the signal level converter; and a signal processor to process the decoded picture signal to be displayed on the display part.

A detailed description of decoding the additional information follows. The decoding part detects if the picture signal comprises the additional information while decoding the converted picture signal. Generally, the additional information exists in the 21st and 284th scanning lines of the picture signal. If the additional information exists therein, the decoding part extracts an additional signal corresponding to the additional information among the converted picture signals and decodes the extracted additional signal. Then, the signal processor processes pictures and the additional signal according to the picture signals which are decoded and output from the decoding part, and the display part displays the pictures and the additional information thereon. At this time, the signal processor comprises an OSD generator and provides OSD additional information to display the additional information, for example, captions, according to the additional signal on the display part.

Here, the decoding part receives the picture signal which is converted and output from the signal level converter, and decodes it according to a predetermined value. Accordingly, the signal level converter converts the picture signal into a signal level optimum for decoding, and provides it with the decoding part.

However, in the conventional display apparatus, the signal level converter is a circuit which is provided as at least one resistor and capacitor connected in parallel or serial. If the picture signal which is over-modulated or under-modulated is input through the picture signal input part, i.e., if the picture signal which is not considered at the designing process of the signal level converter is input, the decoding part may not receive the picture signal which is converted into the optimum signal level. Thus, the decoding part may not decode the additional signal naturally, and the display part may display distorted additional information thereon.

Accordingly, it is required to adequately change a time constant of the signal level converter by redesigning it to convert the picture signal, which is not considered at the designing stage, into the optimum signal level.

### SUMMARY OF THE INVENTION

Accordingly, it is an aspect of the present invention to provide a display apparatus and a control method thereof which maintains an optimum signal level automatically and displays quality additional information and better pictures, regardless of whether signals are input which are over-modulated or under-modulated.

Additional aspects and/or advantages of the present invention will be set forth in part in the description which follows and, in part, will be obvious from the description, or may be learned by practice of the present invention.

The foregoing and/or other aspects of the present invention are also achieved by providing a display apparatus to receive a signal which comprises at least one of additional information and picture information, and process and display the signal, comprising a signal input part to receive the signal; a signal processor to convert the signal received through the signal input part into a predetermined signal level; and a controller to detect the signal level of the additional information among the signals output from the signal processor to compare with a predetermined reference signal level, and control the signal processor to output the signal level of the additional information as the reference signal level if the output signal level of the addition information and the reference signal level are different each other.

According to an aspect of the present invention, the signal processor comprises a signal amplifier to convert the signal received through the signal input part into the predetermined signal level and output it.

According to an aspect of the present invention, the controller comprises an input port to receive the signal to detect the signal level of the additional information among the signals output from the signal processor, and a control port to output a control signal to control the signal amplifier to output the signal level of the additional information as the reference signal level.

According to an aspect of the present invention, the display apparatus further comprises a decoding part having a decoder to decode the signal output from the signal processor according to a predetermined value and output it, and the decoding part comprises the controller.

According to an aspect of the present invention, the input port comprises an ADC port to convert the signal output from the signal processor into a digital form and receive it, and the controller calculates the average of the signal level of the additional information by frame among the signals in the digital form received through the ADC port, and compares the average of the signal level of the additional information by frame with the reference signal level.

According to an aspect of the present invention, the controller controls the decoder to decode and output the additional information among the signals output from the signal processor if the average of the signal level of the additional information is equivalent to the reference signal level.

The foregoing and/or other aspects of the present invention are also achieved by providing a control method of a display apparatus to receive a signal comprising at least one of additional information and picture information, and process and display the signal, comprising converting the received signal into a predetermined signal level through a signal processor which converts the signal level according to a predetermined gain value; comparing the signal level of the additional information among the converted signals with a predetermined reference signal level by detecting the signal level of the additional information; and controlling the signal processor to output the signal level of the additional information as the reference signal level if the output signal level of the additional information is different from the reference signal level.

According to an aspect of the present invention, the controlling the signal processor comprises adjusting the size of a reference voltage supplied to the signal processor to output the signal level of the additional information as the reference signal level.

According to an aspect of the present invention, the comparing comprises converting the converted signal into a digital form, calculating the average of the signal level of the additional information by frame among the signals in the digital form and comparing the average of the signal level of the additional information by frame with the reference signal level.

According to an aspect of the present invention, the control method further comprises decoding the additional information among the signals output from the signal processor to output it if the average of the signal level of the additional information by frame is equivalent to the reference signal level.

According to an aspect of the present invention, the control method further comprises decoding the signal converted through the signal processor, determining if the additional information exists among the signals during the decoding the additional information, and performing the comparing the average of the signal level of the additional information with the reference signal level if it is determined that the additional information exists therein.

According to an aspect of the present invention, the signal processor comprises a signal amplifier to convert the received signal into a predetermined signal level according to the predetermined gain value to output it.

### BRIEF DESCRIPTION OF THE DRAWINGS

The above and/or other aspects and advantages of the present invention will become apparent and more readily appreciated from the following description of exemplary embodiments, taken in conjunction with the accompanying drawings of which:

FIG. 1 is a control block diagram of a display apparatus consistent with an exemplary embodiment of the present invention;

FIG. 2 is a partial control block diagram of the display apparatus consistent with an exemplary embodiment of the present invention; and

FIG. 3 is a control flow chart of an operation of the display apparatus consistent with an exemplary embodiment of the present invention.

### DETAILED DESCRIPTION OF EXEMPLARY EMBODIMENTS OF THE INVENTION

Reference will now be made in detail to embodiments of the present invention, examples of which are illustrated in the accompanying drawings, wherein like reference numerals refer to like elements throughout.

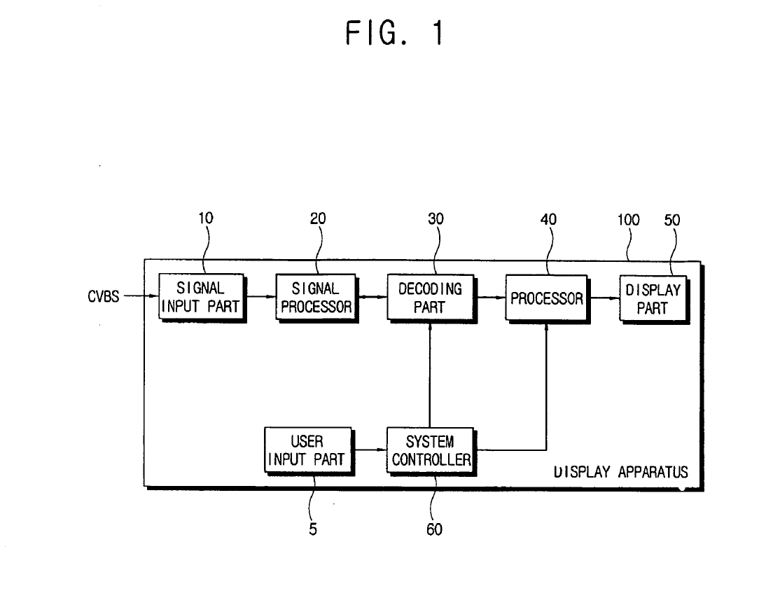

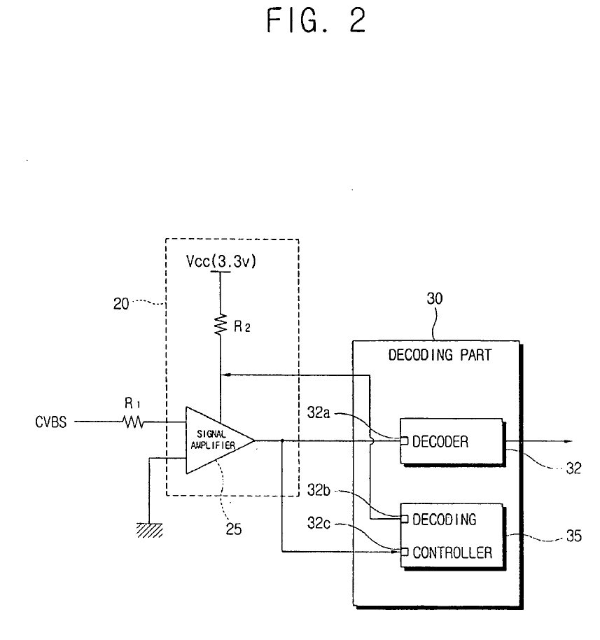

As shown in FIGS. 1 and 2, a display apparatus 100 according to the present embodiment comprises a display part 50; a signal input part 10 to receive a signal comprising at least one of additional information and picture information; a signal processor 20 to convert the signal input through the signal input part 10 into a predetermined signal level; a decoding part 30 comprising a decoder (not shown) to decode and output the signal output from the signal processor 20 according to a predetermined value; a processor 40 to process pictures and captions according to the decoded signal to be displayed on the display part 50; a user input part 5 to output a key input signal by a user's operation; and a system controller 60 to control the decoding part 30 and the processor 40 to perform operations such as captioning and displaying pictures, according to the key input signal.

Preferably but not necessarily, the additional information comprises at least one of caption data, V-CHIP data and TTX data. The caption data will be described as an example of the additional information according to an embodiment of the present invention.

The display part 50 receives the picture and the caption signal from the processor 40 to display them thereon. The display part 50 comprises a display panel (not shown) to display the picture and the captions thereon; and a panel driver (not shown) to process the signal input from the processor 40 and display it on the display panel (not shown). The display part (not shown) and the panel driver (not shown) may vary according to display types.

The signal input part 10 receives the signal which comprises at least one of the caption information and the picture information. The signal input part 10 may be provided as a CVBS input part or an S-video input part to receive an analog signal such as a composite video signal (CVBS) or an S-video signal, a component input part to receive a component signal; and a PC input part to receive a signal including the caption information. In the display apparatus 100 according to the present embodiment of the present invention, the CVBS is input through the signal input part 10, and the signal input part 10 comprises the CVBS input part.

The signal processor 20 converts the CVBS received from the signal input part 10 into a predetermined signal level. The signal processor 20 comprises a signal amplifier 25 (FIG. 2) which coverts the CVBS received through the signal input part 10 into the predetermined signal level by using a predetermined gain value.

The decoding part 30 comprises a decoder 32 to decode and output the signal from the signal processor 20 according to the predetermined value; and a decoding controller 35 to control the signal processor 20 to detect the signal level of the caption information from the signals output from the signal processor 20 to compare it with a predetermined reference signal level, and output the caption signal level as the reference signal level if the output caption signal level and the reference signal level are different from each other.

Referring to FIG. 2, the signal processor 20 and the decoding part 30 will be described in detail. Micronas SDA55xx Series model will be explained as an example of the decoding part 30 according to the present invention. The signal processor 20 preferably but not necessarily converts the caption signal level of the input CVBS into 1V (±0.1V) as an optimum signal level to be processed from the decoding part 30. That is, the reference signal level is 1V which is optimum to be processed from the decoding part 30.

The signal processor 20 comprises the signal amplifier 25 to convert and output the signal received through the signal input part 10 into the predetermined signal level by using the predetermined gain value; and a reference voltage Vcc to be supplied to the signal amplifier 25 continuously. Preferably but not necessarily, the signal amplifier 25 converts the caption signal level of the input CVBS into 1V (±0.1V) according to the gain value. The signal amplifier 25 converts the CVBS through the gain value, and the signal level of the CVBS varies according to the size of the input reference voltage Vcc. If receiving a low reference voltage, for example 3V, the signal amplifier 25 outputs a CVBS at a signal level lower than that when receiving the reference voltage Vcc of 3.3V.

The decoding part 30 comprises the decoder 32 having a signal port 32a to receive the CVBS converted and output from the signal amplifier 25, and decoding the CVBS input through the signal port 32a according to the predetermined value to output it to the processor 40; and a decoding controller 35 having an ADC port 32c to receive the CVBS to detect the signal level of the caption information among the CVBS output from the signal amplifier 25, and a control port 32b to continuously output a control signal to adjust the size of the reference voltage Vcc supplied to the signal amplifier 25 to make the caption signal level detected through the ADC port 32c output as the reference signal level of 1V (±0.1V). That is, the decoding controller 35 continuously outputs the predetermined control signal through the control port 32b to output the caption signal level (1V ±0.1V) by converting the signal level from the signal amplifier 25. Here, the ADC (analog to digital converter) port 32c is an input port to receive the CVBS output from the signal amplifier 25 by converting it into a digital form.

The decoding controller 35 determines if the caption information exists in the CVBS as the decoder 32 decodes the CVBS converted and output from the signal amplifier 25. The decoding controller 35 may determine through detection of the 21^{st} or 284^{th} scanning line of the CVBS in which the caption information exists in general. The decoding controller 35 receives the CVBS output from the signal amplifier 25 through the ADC port 32c in digital form, and calculates the average of the signal level of the caption information by frame if it is determined that the caption information exists therein. That is, the decoding controller 35 detects the signal level of the 21^{st} and 284^{th} scanning lines by frame, in which the caption information of the input CVBS exists, and calculates the average of the signal level of the 21^{st} and 284^{th} scanning lines, by frame. Thus, the decoding controller 35 compares the calculated average of the caption signal level of a single frame and the reference signal level of 1V (±0.1V) whenever each frame is input.

The decoding controller 35 outputs the control signal through the control port 32b to adjust the size of the reference voltage Vcc input to the signal amplifier 25 to output the average of the caption signal level as the reference signal level of 1V (±0.1V) if the average of the caption signal level and the reference signal level of 1V (±0.1V) are different from each other. For example, if the average of the caption signal level of the currently input frame is determined to be 0.8V, the decoding controller 35 increases the voltage size of the predetermined control signal output through the control port 32b. Then, the size of the reference voltage Vcc supplied to the signal amplifier 25 increases, and the average of the caption signal level converted and output from the signal amplifier 25 increases to be equivalent to the reference signal level of 1V (±0.1V).

If the calculated average of the caption signal level is the same as the reference signal level of 1V (±0.1V), the decoding controller 35 determines that the signal level conversion of the signal amplifier 25 is normal, and controls the decoder 30 to decode the caption information among the CVBS input through the signal port 32a together with the picture information and output them to the processor 40.

Thus, the display apparatus 100 according to the present invention may continuously control the signal processor 20 to convert the signal into the optimum signal level to be processed from the decoding part 30, regardless of the condition of the input signal. The display apparatus 100 according to the present invention may display optimum captions always, thereby avoiding a conventional inefficient process which changes a time constant through redesign to prevent distorted captions caused by an over-modulated or under-modulated input signal.

The processor 40 converts the signal comprising at least one of the caption signal and the picture signal which are decoded and output from the decoding part 30, and outputs it to the display part 50. The processor 40 may comprise an OSD generator (not shown) to generate an OSD caption signal to display the captions corresponding to the caption signal, to the display part 50, and a scaler (not shown) to convert the OSD caption signal from the OSD generator (not shown) and the picture signal to be processed from the display part 50.

Here, the CVBS is provided to describe the operation of the display apparatus 100 according to the present embodiment. Various signals, such as a component signal or an RGB signal, may be applicable as long as they comprise the caption information.

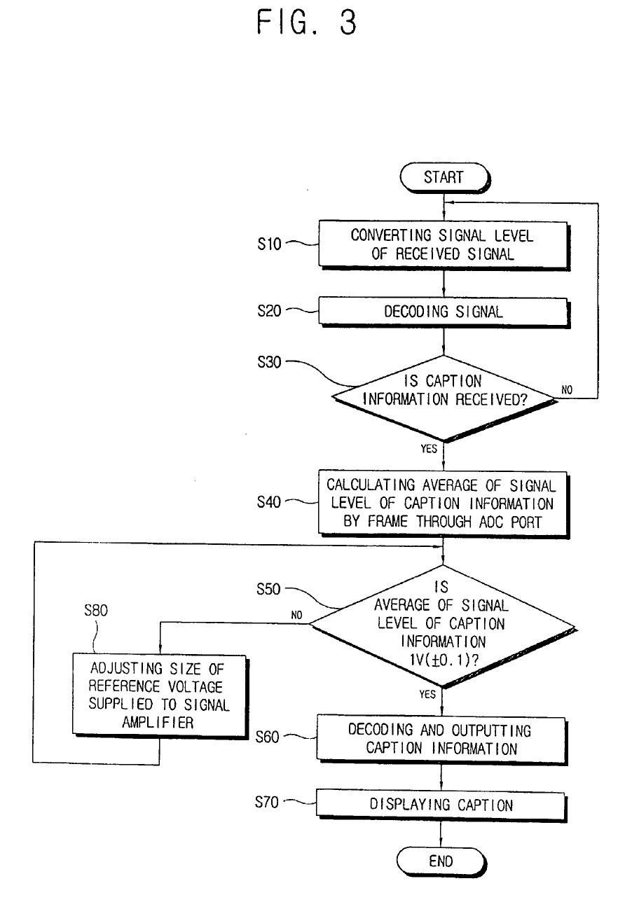

Referring to FIG. 3, the control flow of the display apparatus 100 according to an exemplary embodiment will be described.

First, the signal processor 20 having the predetermined gain value converts the CVBS received through the signal input part 10 into the predetermined signal level by using the gain value and outputs it at operation S10. The decoder 32 of the decoding part 30 decodes the converted CVBS at operation S20. At this time, the decoding controller 35 determines if the caption information exists in the CVBS through the decoding process S20, at operation S30. The decoding controller 35 may determine the existence of the caption information through detection of the 21st or 284th scanning line of the CVBS in which the caption information generally exists. If it is determined that the caption information exists therein, the decoding controller 35 receives the CVBS converted from the signal processor 20 through the ADC port 32c, and calculates the average of the signal level of the caption information by frame at operation S40. That is, the decoding controller 35 detects the signal level of the 21st and 284th scanning lines by frame in which the caption information of the input CVBS exists, and calculates the average of the signal level of the 21st and 284th scanning lines. Thus, the decoding controller 35 determines if the calculated average of the caption signal level of the single frame is equivalent to the reference signal level of 1V (±0.1V) at operation S50. Here, the operation S50 is performed for each frame of the input signal.

If the calculated average of the caption signal level is not equivalent to the reference signal level of 1V (±0.1V), the decoding controller 35 adjusts the size of the reference voltage Vcc input to the signal amplifier 25 of the signal processor 20 to output the average of the caption signal level as the reference signal level of 1V (±0.1V), at operation S80. If the average of the caption signal level is lower than the reference signal level of 1V (±0.1V), the decoding controller 35 controls and outputs the control signal to input a reference voltage Vcc2 larger than the previous reference voltage Vcc1 to the signal amplifier 25. If the average of the caption signal level is larger than the reference signal level of 1V (±0.1V), the decoding controller 35 controls and outputs the control signal to input a reference voltage Vcc0 smaller than the previous reference voltage Vcc1 to the signal amplifier 25. Then, the decoding controller 35 determines if the average of the caption signal level is equivalent to the reference signal level of 1V (±0.1V) at operation S50.

If it is determined that the average of the caption signal level is equivalent to the reference signal level of 1V (±0.1V) at operation S50, the decoding controller 35 determines that the conversion of the signal level of the signal amplifier 25 is normal, and controls the decoder 30 to decode the caption information among the CVBS input through the signal port 32a together with the picture information, for output at operation S60. Thus, the processor 40 processes the picture signal and the caption signal of the CVBS, and the display part 50 displays the picture and captions thereon at operation S70.

As described above, the display apparatus 100 and the control method thereof according to the present invention may continuously control the signal processor 20 to convert the signal into the optimum signal level to be processed from the decoding part 30, regardless of the condition of the input signal. Thus, the display apparatus 100 and the control method thereof according to the present invention may display the optimum captions always, thereby avoiding the conventional inefficient process which changes the time constant through redesign to prevent distorted captions caused by an over-modulated or under-modulated input signal.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display apparatus to receive a signal which comprises at least one of additional information and picture information, and process and display the signal, comprising:
a signal input part to receive the signal;
a signal processor to convert the signal received through the signal input part into a predetermined signal level; and
a controller to detect the signal level of the additional information among the signals output from the signal processor to compare the signal level of the additional information with a predetermined reference signal level, and to control the signal processor to output the signal level of the additional information as the reference signal level if the output signal level of the addition information and the reference signal level are different from each other.

2. The display apparatus according to claim 1, wherein the signal processor comprises a signal amplifier to convert the signal received through the signal input part into the predetermined signal level and output the signal converted by the signal amplifier.

3. The display apparatus according to claim 2, wherein the controller comprises an input port to receive the signal converted by the signal amplifier to detect the signal level of the additional information among the signals output from the signal processor, and a control port to output a control signal to control the signal amplifier to output the signal level of the additional information as the reference signal level.

4. The display apparatus according to claim 3, further comprising a decoding part having a decoder to decode the signal output from the signal processor according to a predetermined value and output it, and the decoding part comprises the controller.

5. The display apparatus according to claim 4, wherein the input port comprises an ADC port to convert the signal output from the signal processor into digital signals and to receive the digital signals, and the controller calculates the average of the signal level of the additional information by frame among the digital signals received through the ADC port, and compares the average of the signal level of the additional information by frame with the reference signal level.

6. The display apparatus according to claim 5, wherein the controller controls the decoder to decode and output the additional information among the signals output from the signal processor if the average of the signal level of the additional information is equivalent to the reference signal level.

7. The display apparatus according to claim 3, wherein the input port comprises an ADC port to convert the signal output from the signal processor into digital signals and receive the digital signals, and the controller calculates the average of the signal level of the additional information by frame among the digital signals received through the ADC port, and compares the average of the signal level of the additional information by frame with the reference signal level.

8. The display apparatus according to claim 7, wherein the controller controls the decoder to decode and output the additional information among the signals output from the signal processor if the average of the signal level of the additional information is equivalent to the reference signal level.

9. A control method of a display apparatus to receive a signal comprising at least one of additional information and picture information, and process and display the signal, comprising:
converting the received signal into a predetermined signal level through a signal processor which converts the signal level according to a predetermined gain value;
comparing the signal level of the additional information among the converted signals with a predetermined reference signal level by detecting the signal level of the additional information; and
controlling the signal processor to output the signal level of the additional information as the reference signal level if the output signal level of the additional information is different from the reference signal level.

10. The control method according to claim 9, wherein the controlling the signal processor comprises adjusting the size of a reference voltage supplied to the signal processor to output the signal level of the additional information as the reference signal level.

11. The control method according to claim 10, wherein the comparing comprises converting the converted signal into digital signals, calculating the average of the signal level of the additional information by frame among the digital signals and comparing the average of the signal level of the additional information by frame with the reference signal level.

12. The control method according to claim 11, further comprising decoding the additional information among the signals output from the signal processor to output the additional information if the average of the signal level of the additional information by frame is equivalent to the reference signal level.

13. The control method according to claim 12, further comprising decoding the signal converted through the signal processor, determining if the additional information exists among the signals during the decoding the additional information, and performing the comparing the average of the signal level of the additional information with the reference signal level if it is determined that the additional information exists therein.

14. The control method according to claim 13, wherein the signal processor comprises a signal amplifier to convert the received signal into a predetermined signal level according to the predetermined gain value to output the converted received signal.
